(19) United States
(12) Patent Application Publication
(10) Pub. No.: US 2011/0279902 A1
(43) Pub. Date: Nov. 17, 2011

(54) SYSTEM AND METHOD FOR REDUCING ENVIRONMENTAL EFFECT ON VERIFYING CONTENT DISPLAYED ON AN ELECTRONIC VISUAL DISPLAY

(76) Inventors: John Freeman, East Orange, NJ (US); Robert Thompson, Parsippany, NJ (US); Robert Wolinsky, Fairfield, CT (US); Mikhail Marsky, Ramsey, NJ (US); Peter Daly, Yorktown Heights, NY (US)

(21) Appl. No.: 13/035,550

(22) Filed: Feb. 25, 2011

Related U.S. Application Data
(60) Provisional application No. 61/307,906, filed on Feb. 25, 2010.
(60) Provisional application No. 61/368,394, filed on Jul. 28, 2010.
(60) Provisional application No. 61/414,816, filed on Nov. 17, 2010.

(51) Int. Cl. G02B 26/02

(52) U.S. Cl. 359/613; 359/601

(57) ABSTRACT

An electronic display may include a screen including an outer perimeter and front surface. A housing may include a trim ring that surrounds the outer perimeter and extends in front of the front surface of the screen. An optical sensor shield may be is positioned at least in part in front of the front surface of the screen. An optical sensor may be disposed between the optical sensor shield and the screen to reduce the ability for ambient light to illuminate the optical sensor.

### CROSS REFERENCE TO RELATED APPLICATIONS

This Application claims priority to co-pending U.S. Provisional Patent Applications 61/307,906 filed on Feb. 25, 2010, 61/368,394 filed on Jul. 28, 2010, and 61/414,816 filed on Nov. 17, 2010, the contents of which are herein incorporated by reference in their entirety.

### BACKGROUND OF THE INVENTION

Electronic displays are used to convey information to people using content. Content may be in the form of still images, graphical images, video, etc. As described in co-pending U.S. Pat. No. 7,742,950, advertising content may be displayed on electronic displays within a retail environment (e.g., retail stores, shopping malls, sports venues) or on outdoor electronic displays (e.g., electronic billboards) to enable people to view the advertising content being displayed. Whether displayed by print or electronic display, advertisers desire to verify that their advertisements were timely (e.g., date/time) and properly displayed (e.g., colors correctly displayed, registration correct, image actually displayed). As described in U.S. Pat. No. 7,614,065 to Weissmueller et al., content verification may be performed by (i) displaying a verification signal in conjunction with the advertising content and (ii) sensing the verification signal being displayed on the electronic display with an optical sensor.

One problem that exists with sensing a visual verification signal being displayed by an electronic display is ambient light being illuminated onto an optical sensor so as to be sensed by the optical sensor in addition to sensing the visual verification signal. Ambient light can cause a variety of optical sensing problems, such as increased optical noise levels, as understood in the art. Ambient light may include direct or indirect lighting from sources. In indoor environments (e.g., within a retail store), ambient light may include light produced by light bulbs, sunlight, light from automobile headlights, and other light produced by other light sources. In outdoor environments, ambient light may include sunlight, light from street lights, light from automobile headlights, moonlight, or light from other light sources. In the case of sensing a verification signal being displayed by an electronic display, ambient light may be illuminated onto the optical sensor either directly or indirectly by being illuminated onto a display surface (e.g., viewing glass) of the optical display and reflected from the rear of the display surface or display elements (e.g., LEDs, LCDs, etc.) behind the display surface.

A second problem that exists for sensing the visual verification signal is manufacturing accuracy in aligning the optical sensor with a pixel area displaying the visual verification signal. The pixel area may vary in physical size depending on size of display, size of pixels, size of optical sensor, environment in which the visual verification signals are being displayed, etc. In one embodiment, the visual verification signals are produced by a 5×5 pixel array, which is small to limit distraction of viewers. Depending on the size of pixels of the electronic display, such a pixel array may be as small as tens of millimeters in size, which may be the same or smaller size than the optical sensor. Aligning an optical sensor small enough to collect sensor signals from a 5×5 pixel array onto an electronic display is difficult from an accuracy and repeatability standpoint for a manufacturer. Moreover, small variations of accuracy may be problematic for sensing the visual verification signal, especially when taking into account that (i) pixels outside of the pixel area displaying the visual verification signals may be displaying other content and (ii) ambient light may impact sensing of visual verification signals, as previously described.

### SUMMARY OF THE INVENTION

To address the problems of ambient light negatively affecting (i) sensing of a visual verification signal being displayed on an electronic display signal and (ii) accurately aligning an optical sensor to sense the visual verification signal, the principles of the present invention provide for a number of techniques for attenuating or eliminating ambient light from illuminating an optical sensor and accurately aligning the optical sensor on an electronic display, either as an original equipment of manufacture or as an add-on device to an existing electronic display. To attenuate or eliminate ambient light from illuminating the optical sensor, the principles of the present invention provide for providing an optical sensor shield for the optical sensor that provides both shielding of ambient light and aligning of the optical sensor with the pixel area displaying the visual verification signal.

One embodiment of an electronic display may include a screen including an outer perimeter and front surface. A housing may include a trim ring that surrounds the outer perimeter and extends in front of the front surface of the screen. An optical sensor shield may be positioned at least in part in front of the front surface of the screen. An optical sensor may be disposed between the optical sensor shield and the screen to reduce the ability for ambient light to illuminate the optical sensor.

One embodiment of a method of manufacturing an electronic display may include providing a screen including an outer perimeter and front surface. A housing may be connected to the screen, where the housing may include a trim ring that surrounds the outer perimeter of the screen. An optical sensor shield may be connected to the housing, where the optical sensor shield may be positioned at least in part in front of the front surface of the screen. An optical sensor may be positioned between the optical sensor shield and the screen.

One embodiment of a method for displaying a visual verification signal may include designating pixels of a screen that are positioned behind and adjacent to an outer perimeter of an optical sensor shield covering at least a portion of the screen. A visual verification signal may be displayed by the selected designated pixels.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an illustration of a front view of an illustrative electronic display assembly including a housing;

FIG. 2 is an illustration of a perspective view of the electronic display assembly that shows the optical sensor shield extending over a portion of the display mask and screen;

FIGS. 3 and 4 are illustrations of opposing side views of the electronic display assembly mounted to a visual discriminator;

FIG. 5 is an illustration of a top view of the electronic display assembly showing the optical sensor shield extending slightly forward of the trim ring;

FIG. 6 is an illustration of a front view of the electronic display assembly as shown in FIG. 1;

FIG. 7 is an illustration of a magnified view of the optical sensor shield of FIG. 1;

FIG. 8 is an illustration of a bottom perspective view of the trim ring 108 that includes the optical sensor shield;

FIG. 9 is an illustration of a top isometric view of the trim ring that includes the optical sensor shield, as described with regard to FIG. 8;

FIG. 10A is an illustration of a front view of the electronic display assembly of FIG. 1 displaying an illustrative visual verification signal;

FIG. 10B is an illustration of an illustrative portion of the screen displaying the verification signal;

FIGS. 11A-11E are illustrations of an illustrative electronic display assembly;

FIGS. 12A-12E are illustrations of another illustrative electronic display assembly;

FIGS. 13A-13F are illustrations of an alternative electronic display assembly configuration;

FIGS. 14A-14F are illustrations of another alternative electronic display assembly configuration;

FIG. 15 is an illustration of an illustrative electronic display that depicts a light emitting element with an optical sensor or signal sensing device being positioned on a display surface of the electronic display;

FIG. 16 is an illustration of an alternative embodiment of an electronic display including a display surface being altered in a localized region to enable an optical sensor or signal sensing device to be positioned therein;

FIG. 17 is an illustration of an illustrative sensing system including an optical sensor being positioned within an etched region of a display surface of an electronic display;

FIG. 18 is an illustration of a front view of the content light emitting element;

FIG. 19 is an illustration of an alternative embodiment of an optical sensing system;

FIGS. 20A and 20B are illustrations of another embodiment of an optical sensing system in which an opaque covering may be disposed on top of an optical sensor;

FIGS. 21A and 21B are illustrations of yet another embodiment of a light sensing system in which a region of pixels of the content light emitting element around a pixel region (not shown) used to display a verification code are set to black;

FIG. 22 is a flow diagram of an illustrative process for manufacturing an electronic display; and

FIG. 23 is a flow diagram of an illustrative process for displaying a visual verification signal.

### DETAILED DESCRIPTION OF THE DRAWINGS

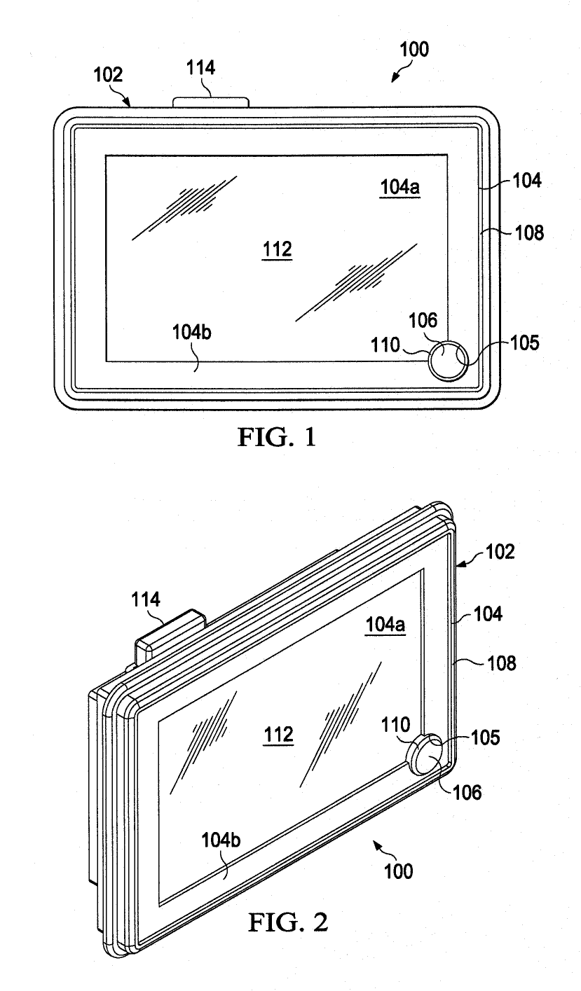

With regard to FIG. 1, an illustration of a front view of an illustrative electronic display assembly 100 including a housing 102 is shown. The housing 102 may include a display mask assembly 104 that includes a protective transparent display mask (e.g., Plexiglas or glass) within a ring perimeter frame 104b. The ring perimeter frame 104b may be formed of plastic, metal, or any other material and may include a cutout 105, which is circular in this case.

An optical sensor shield 106 may be integrated into a trim ring 108, where the display mask 104 may be disposed within or integrate with the trim ring 108. As shown, the optical sensor shield 106 extends through the cutout 105. The optical sensor shield 106 being integrated with the trim ring 108 means that the optical sensor shield 106 may be formed as part of or attached to the trim ring 108. The integration may be performed using the same manufacturing process (e.g., metal stamping or plastic injection molding) as performed for making the display trim ring 108. Alternatively, a different manufacturing process may be used and attachment elements may be included on the trim ring 108, and corresponding attachment elements may be included on the optical sensor shield 106. Other non-integration configurations of the optical sensor shield may be utilized in accordance with the principles of the present invention. Rather than the optical sensor shield 106 being part of or attached to the trim ring 108, the optical sensor shield 106 may be connected to another structure (e.g., rear of housing 102) of the electronic display assembly 100. Alternatively, the optical sensor shield 106 may be connected to a structure from which the electronic display is being suspended, especially if the optical sensor shield 106 is being added to an existing electronic display assembly 100 not originally configured to perform optical sensing. In such a non-integration embodiment, a force may be applied to the screen from the optical sensor shield to maintain position of the optical sensor shield.

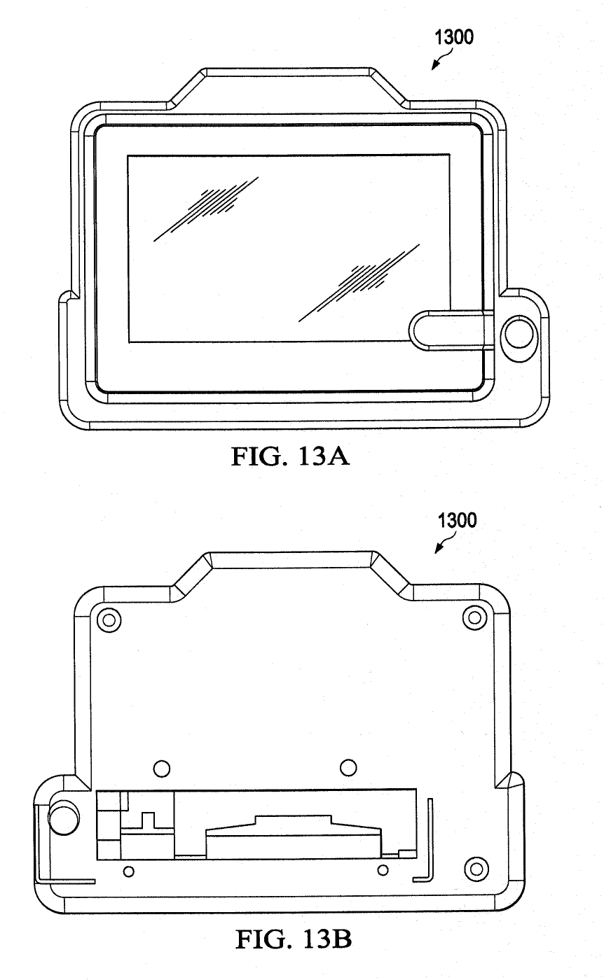

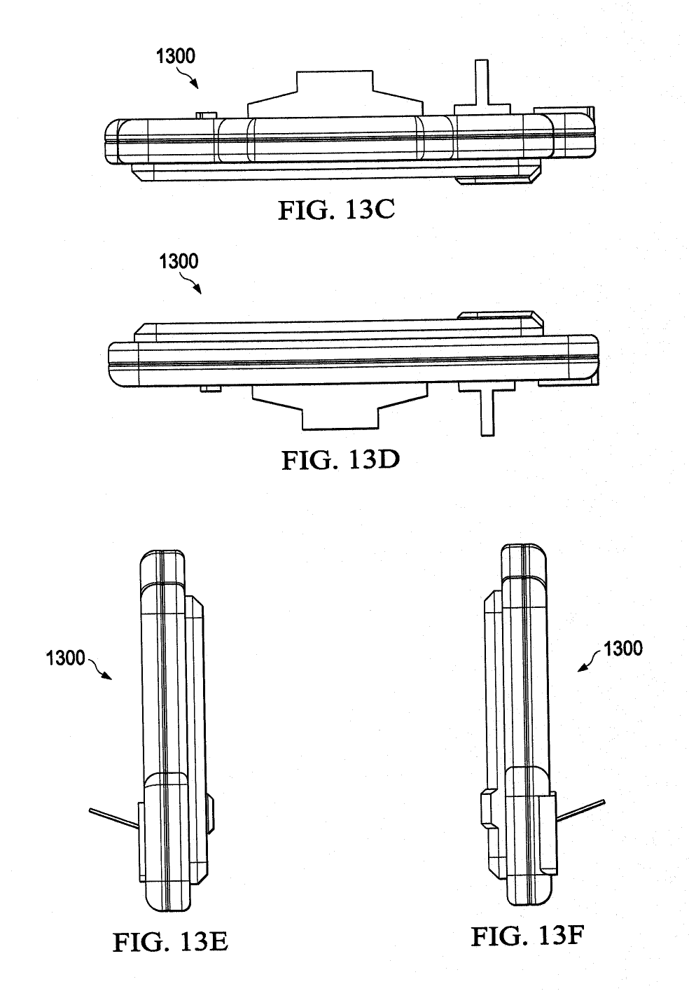

As shown, the optical sensor shield 106 extends over a portion of a screen 112 of the electronic display assembly 100. Although shown in a circular configuration, the optical sensor shield 106 may be any shape, such as a “thumb” shape (see FIG. 13). By using a circular or “thumb” shape, an ornamental design is provided. The optical sensor shield 106 may be any other shape, such as a star or company logo in accordance with the principles of the present invention. As can be seen, the optical sensor shield 106 includes a bevel 110 between the front surface and outside surface, thereby giving a “suspended look” to the optical sensor shield 106. From a functional viewpoint, the optical sensor shield 106 provides shielding of the optical sensor from ambient light.

Although not specifically depicted, the display mask 104a formed of a transparent material, such as Plexiglas or glass, may be disposed in front of the screen 112. The display mask 104a may be adhered to the screen 112 or a small air gap may exist, and the ring perimeter frame 104b may be partially covered by the trim ring 108. The display mask 104a may protect the screen 112 from becoming damaged as a result of intentional or unintentional contact, and provide some level of ambient light shielding, as further described herein. The display mask 104a may have an anti-reflective coating to reduce reflection, as well.

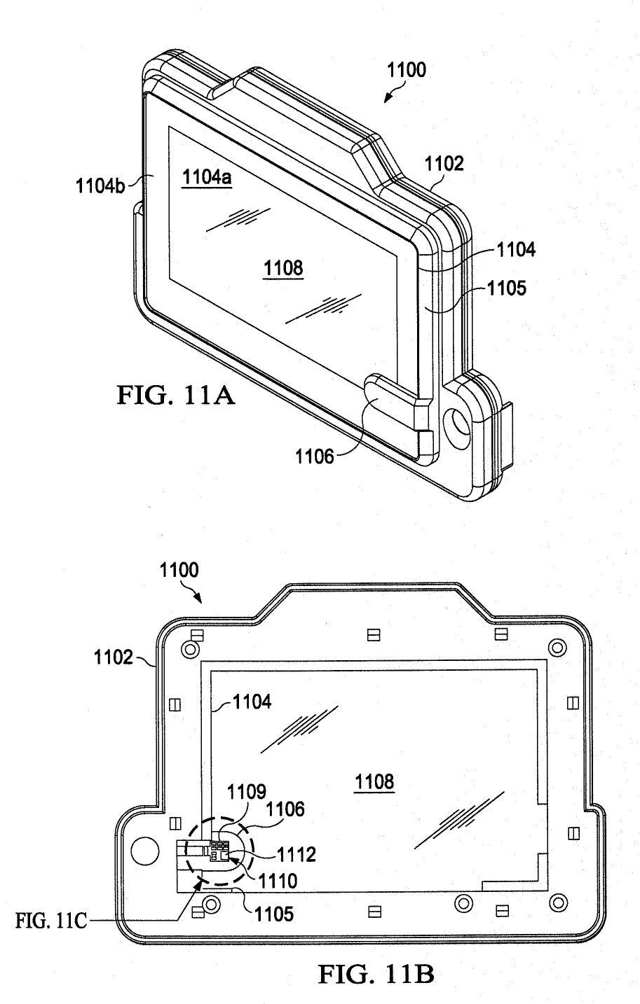

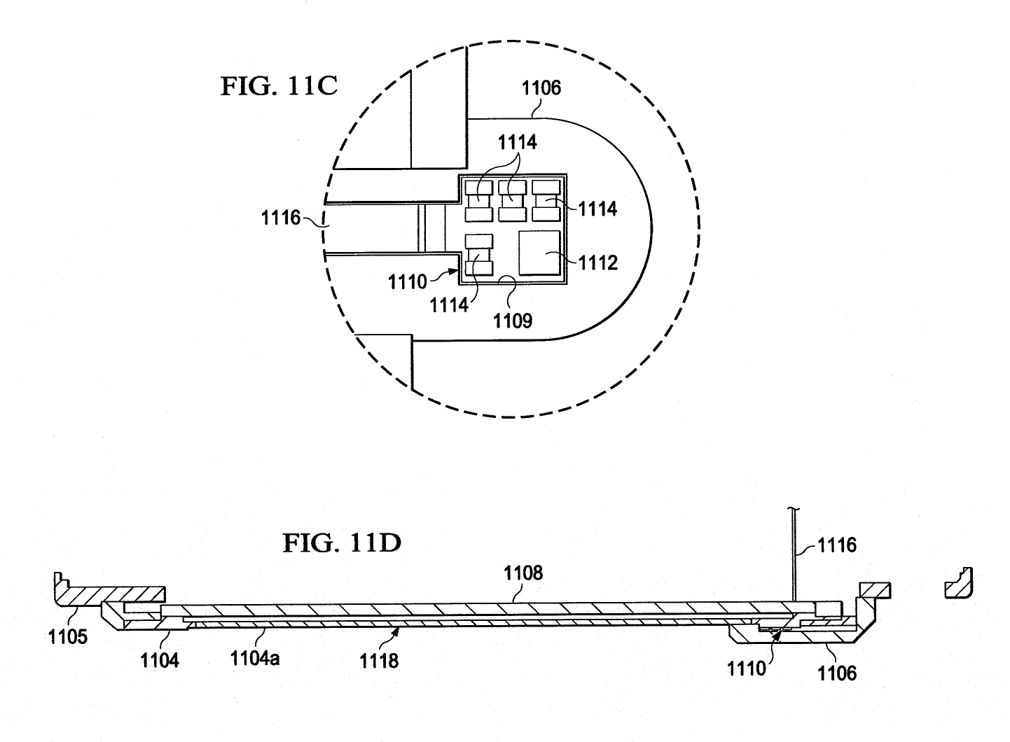

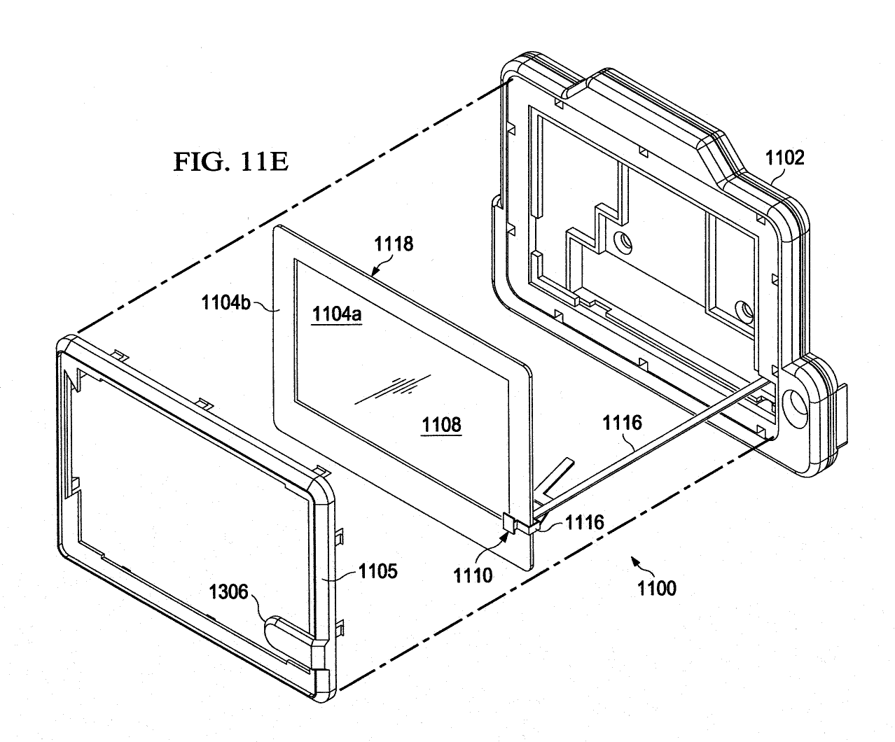

The ring perimeter frame 104b and trim ring 108 provide an ornamental design that is “clean” in appearance. In one embodiment, the housing 102 may extend beyond the trim ring 108 and be approximately the same color as the ring perimeter frame 104b, thereby maintaining the “clean” appearance. Alternatively, contrasting colors, such as the ring perimeter frame 104b being black and the trim ring 108 being silver, may provide a contrast to focus a viewer's attention on content being displayed on the screen 112, which resides behind the display mask 104a (see FIG. 11D).

An antenna cover 114 is shown to extend along the top edge of the housing 102 of the electronic display assembly 100, and may be configured to cover an antenna (not shown) that is positioned within the antenna cover 114. Accordingly, the antenna cover 114 may include an internal cavity (not shown) to allow the antenna to extend from the housing 102. Other shapes and configurations of an antenna cover may be utilized. Alternatively, a different antenna design may be used so as to not show an antenna cover at all. The shape of the antenna cover 114 may provide for a distinct ornamental feature.

With regard to FIG. 2, an illustration of a perspective view of the electronic display assembly 100 that shows the optical sensor shield 106 extending over a portion of the display mask 104a and screen 112 is shown. In one embodiment, the optical sensor shield 106 may have a flat front surface. Alternatively, the optical sensor shield 106 may have a non-flat surface, such as a concave or convex surface. In addition, the front surface of the optical sensor shield 106 may be coplanar with the front surface of the ring perimeter frame 104b. Alternatively, the front surfaces of the optical sensor shield 106 and ring perimeter frame 104b are not coplanar.

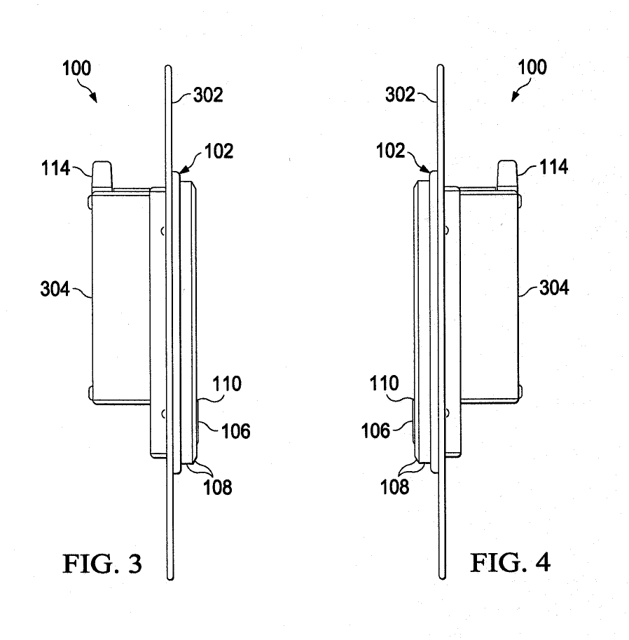

With regard to FIGS. 3 and 4, illustrations of opposing side views of the electronic display assembly 100 mounted to a visual discriminator 302 are shown. The visual discriminator may be a piece of material that frames the electronic display assembly 100 so as to block background optical “clutter” that may distract a viewer's attention from images being displayed by the electronic display assembly 100. As shown, the optical sensor shield 106 has a non-coplanar profile with the display mask 104. The trim ring 108 and housing 102 are shown to extend in front of the visual discriminator 302 to support a screen (see FIG. 1). A rear housing 304 is used to position, support, and secure electronics (not shown) used to display content, collect content certification information, communicate wireless and/or wired signals, and so on. Alternative configurations of the rear housing 304 may be utilized.

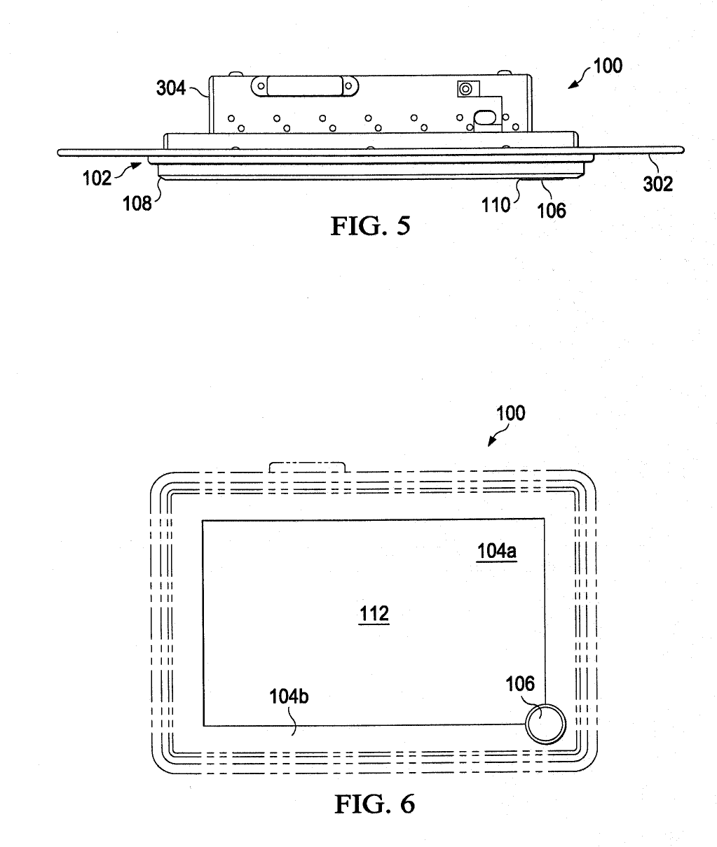

With regard to FIG. 5, an illustration of a top view of the electronic display assembly 100 showing the optical sensor shield 106 extending slightly forward of the trim ring 108 is shown. The electronic display assembly 100 is shown to include the visual discriminator 302 that extends between the rear housing 304 and the housing 102. The rear housing 304 supports and houses electronic printed circuit boards (not shown) that may perform computing, display, and communications functionality. It should be understood that the actual and relative dimensions shown are illustrative, and that alternative dimensions may be utilized in accordance with the principles of the present invention.

With regard to FIG. 6, an illustration of a front view of the electronic display assembly 100 as shown in FIG. 1 is shown. However, because an ornamental feature is provided by the trim ring 108 and optical sensor shield 106, the other lines and surfaces of the electronic display assembly 100 are shown as dashed lines to represent the environment in which the ornamental feature resides. It should be understood that other angular views of the electronic display assembly 100 may also have dashed lines that represent the environment in which the ring perimeter frame 104b and optical sensor shield 106 reside. Although the ring perimeter frame 104 is shown as a rectangular shape, it should be understood that rounded corners, square shape, or other configurations may be utilized and be considered the same or equivalent as the principles of the present invention. Furthermore, although shown as being positioned within the lower right-hand corner, it should be understood that the optical sensor shield 106 may be positioned anywhere along the edge of the screen 112. However, by placing the optical sensor shield 106 in a corner and displaying the visual verification signal on pixels beneath the optical sensor shield 106, a limited amount of the screen 112 is covered, thereby minimizing distraction to viewers. It should be understood that alternative shapes and dimensions of the optical sensor shield 106 may be utilized in accordance with the principles of the present invention. For example, the optical sensor shield 106 may be configured in a “thumb” shape that extends upward or sideways. Other shapes, configurations, and orientations of the optical sensor shield 106 are also contemplated.

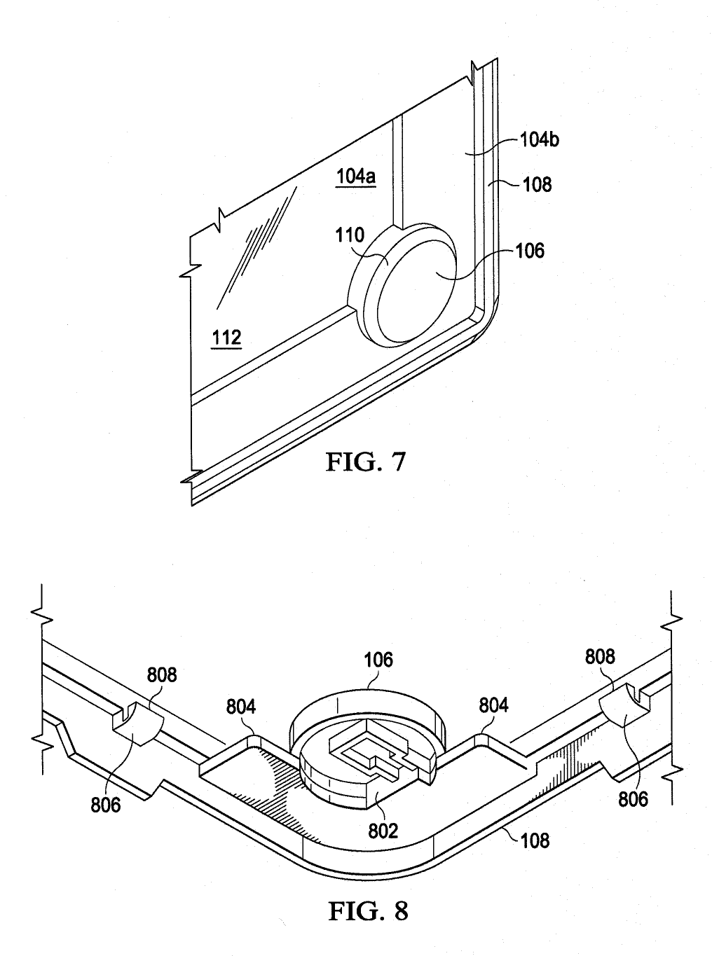

With regard to FIG. 7, an illustration of a magnified view of the optical sensor shield 106 is shown. As shown, the optical sensor shield 106 covers a portion of the screen 112 and display mask 104a. The optical sensor shield 106 includes a bevel 110 that provides a visual appearance that the optical sensor shield 106 is floating. As can be seen, the ring perimeter frame 104b is held behind the trim ring 108. In one embodiment, the trim ring 108 may have a triangular profile to provide some level of texture. Alternatively, the trim ring 108 may be flat or have another profile.

With regard to FIG. 8, an illustration of a bottom perspective view of the trim ring 108 that includes the optical sensor shield 106 is shown. The optical sensor shield 106 is shown to include some structural members 802 that provides strength, and reduces the weight and material used for creating the optical sensor shield 106. The optical sensor shield 106 may be formed of plastic and produced with the trim ring 108 in an injection molding process, as understood in the art. The structural members 802 may be configured to define a cavity within which an optical sensor (not shown) may be mounted, thereby reducing or eliminating ambient light from illuminating the optical sensor. Alternatively, in the case where the optical sensor is connected to a display mask 104a or screen directly, the optical sensor shield 106 may be positioned over the optical sensor to shield the optical sensor from ambient light.

The structural members 802 may be configured in such a manner that one or more electrical conductors (e.g., wires) may pass beneath the optical sensor shield 106 and the display mask assembly 104 so that signals generated by the optical sensor as a result of sensing verification signals displayed on the screen may be communicated to a processing unit within or externally from the electronic display. The structural members 802 may be formed by the same process (e.g., plastic injection molding) that forms the optical sensor shield 106 or a separate process and inserted into a cavity defined by the optical sensor shield 106. In an alternative embodiment, rather than using wires, wireless communications may be performed between the optical sensor and a remote processor.

As further shown, the optical sensor shield 106 may be part of or mounted to the trim ring 108. The optical sensor shield 106 may be formed as part of or be connected to connector members 804 that are used to provide support for the optical sensor shield 106. The connection may be performed using an adhesive, snap, hardware (e.g., screws), fused (e.g., heated) or any other connection mechanism. Furthermore, the connector members 804 may be configured to have a thickness that allows a display mask and/or screen to be clamped or sandwiched between the connector members 804 and brackets 806 that are part of the trim ring 108. As shown, the brackets 806 are extended below the surface of the trim ring 108 and have a shelf 808 that is used to support a screen. It should be understood that alternative configurations for supporting the screen may be utilized in accordance with the principles of the present invention.

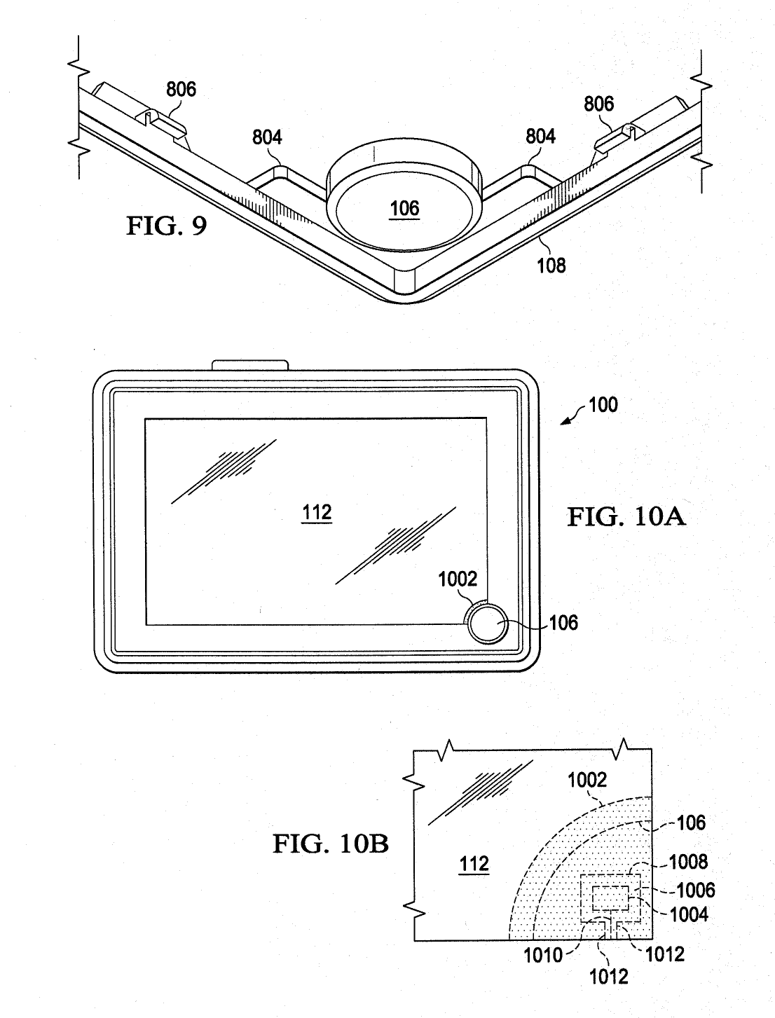

With regard to FIG. 9, an illustration of a top isometric view of the trim ring 108 that includes the optical sensor shield 106, as described with regard to FIG. 8. In configuring the electronic display assembly 100 (FIG. 1), the trim ring 108 may be connected to the display mask assembly 104 (see FIG. 1). The housing 102 (FIG. 1) along with the trim ring 108 may provide support for the display mask assembly 104 and/or screen 112, as further described with respect to FIG. 8.

With regard to FIG. 10A, an illustration of a front view of the electronic display assembly 100 is shown. In this embodiment, the screen 112 is displaying an illustrative visual verification signal 1002 using pixels of the screen 112 that are behind and extend outside of the optical sensor shield. In one embodiment, the visual verification signal 1002 may have approximately the same shape as the perimeter of the optical sensor shield 106. In one embodiment, the visual verification signal 1002 operates by flashing on and off, thereby illuminating the optical sensor (not shown) that is positioned in front of the portion of the screen 112 displaying the visual verification signal 1002 and behind the optical sensor shield 106. In one embodiment, the visual verification signal 1002 is displayed in successive different colors (e.g., three pulses of red, three pulses of green, three pulses of blue). Because the optical sensor is smaller than the area of pixels being used to display the verification signal and the optical sensor is positioned well within the boundaries of the verification signal, alignment of the optical sensor is met. And, because of the configuration of the optical sensor and optical sensor shield 106 being connected to the trim ring 108 of the housing 102, alignment of the optical sensor is effectively guaranteed through the assembly process of the electronic display assembly 100.

If the optical sensor is the same size or larger than the visual verification signal 1002 being displayed, then the configuration of the optical sensor shield may provide sufficient alignment accuracy to ensure that the optical sensor is properly aligned with the visual verification signal 1002. Alignment accuracy may be provided by tolerances of the housing, optical sensor shield, and other components, as understood. In addition, the optical sensor shield may provide for adjustments vertically, horizontally, and/or perpendicularly (i.e., in the Z-axis) using one or more mechanical alignment mechanism (e.g., slides, screws, worm gears, etc.) to allow for slight adjustment of the optical sensor.

With regard to FIG. 10B, an illustration of an illustrative portion of the screen 112 displaying the verification signal 1002 is shown. The optical sensor shield 106 that resides over the screen 112 is depicted as dashed lines. An optical sensor assembly 1004 is positioned within a cavity 1006 formed by a structure 1008, as indicated by dashed lines, beneath a front surface of the optical sensor shield 106. A flex circuit 1010 may extend from the optical sensor assembly 1004 through a passageway formed by structural elements 1012 of the optical sensor shield 106.

As previously alluded to, so that people can see the visual verification signal operating, a small number of pixels immediately adjacent to and extending beyond the perimeter of the optical sensor shield 106 may be designated to display the visual verification signal 1002. In one embodiment, the pixels beyond the optical sensor shield 106 may be in approximately the same shape as the perimeter of the optical sensor shield 106, which in this case, is circular. It should be understood that the number of pixels may be ten or fewer, which is enough to be noticed by a viewer, but not enough to be distracting to the viewer of the content being displayed on the screen 112. Depending on the size of the pixels and size of the screen 112, the number of pixels that are visible beyond the optical sensor shield 106 may be different for aesthetic and viewer distraction reasons. In an alternative embodiment, the verification signal 1002 may be hidden from viewers by being displayed completely behind the optical sensor shield 106.

Other visual verification signal display shapes may be utilized in accordance with the principles of the present invention. By displaying the visual verification signal 1002 slightly beyond the optical sensor shield 106, viewers, including operators of the electronic display assembly 100, may come to recognize the visual verification signal 1002 configuration as a technique that is being used to verify timeliness and correctness of the content being displayed. In addition, the visual verification signal 1002 in combination with the optical sensor shield 106 may provide an ornamental feature for the electronic display assembly 100.

With regard to FIGS. 11A-11E, illustrations of an illustrative electronic display assembly 1100 are shown. As shown in FIG. 11A, the electronic display assembly 1100 includes a housing 1102 and display mask assembly 1104, which includes a display mask 1104a and ring perimeter frame 1104b, as further described below. A trim ring 1105 may include an integrated optical sensor shield 1106. In this embodiment, rather than the optical sensor shield 1106 being circular, the optical sensor shield 1106 is “thumb” shaped and extends horizontally from the side of the electronic display assembly 1100. In being integrated, the optical sensor shield 1106 is molded or otherwise formed as part of the trim ring 1105. In the same manner as previously described with regard to the optical sensor shield 106 (FIG. 1), the optical sensor shield 1106 extends over a portion of a screen 1108 and shields ambient light from illuminating onto an optical sensor (see FIG. 11B) positioned in a cavity (see FIG. 11B) within the optical sensor shield 1106. In an alternative embodiment, the optical sensor shield 1106 may be formed separately from and attached to the trim ring 1105. As shown with FIGS. 10A and 10B, a verification signal (not shown) may be displayed beneath the optical sensor shield 1106 and extend slightly beyond the perimeter of the optical sensor shield 1106 to allow a viewer to notice that the content is being verified without being distracted.

With regard to FIG. 11B, an illustration of a rear view of the housing 1102, display mask 1104, and trim ring 1105 of FIG. 11A is shown. The optical sensor shield 1106 is shown to extend over the screen 1108. A cavity 1109 in the optical sensor shield 1106 is sized to accommodate an optical sensor assembly 1110. The optical sensor assembly 1110 includes an optical sensor 1112 that may be mounted to a support structure (e.g., flexible circuit board or printed circuit board). In one embodiment, the optical sensor assembly 1110 may be bonded or otherwise fixedly attached within the cavity 1109 of the optical sensor shield 1106. In yet another embodiment, the optical sensor assembly 1110 may be mounted to the screen 1108, display mask 1104, or other transparent protective covering of the screen 1108. As shown, the optical sensor 1112 may be positioned in a front corner of the optical sensor assembly 1110. Alternative configurations of placement of the optical sensor 1112 may be utilized in accordance with the principles of the present invention.

With regard to FIG. 11C, a magnified illustration of the optical sensor shield 1106 and cavity 1108 within which the optical sensor assembly 1110 is positioned is shown. The optical sensor 1112 and other electronic components 1114 (e.g., addressing resistors and capacitors) may be mounted to a flex circuit 1116 for communication of signals received by the optical sensor 1112 to an electronic circuit (not shown) positioned in the electronic display assembly 1100 or remotely therefrom.

With regard to FIG. 11D, a top view of the housing 1102, display mask 1104 and trim ring 1105 is shown. A touch-screen assembly 1118 may include a display mask 1104 with a conductive coating (not shown) and trim ring 1105. The display mask 1104 having the conductive coating provides for touch sensitive capabilities to enable a user to interact with information being displayed on the screen 1108, as understood in the art. The optical sensor shield 1106 is positioned in front of the screen 1108 and display mask 1104 and be in contact with the screen 1108 and display mask 1104 so that minimal or no ambient light may enter between the display mask 1104 and the optical sensor shield 1106. In the event that ambient light can enter between the display mask 1104 and optical sensor shield 1106, the optical sensor (not shown) is positioned in such a way that structure within the optical sensor shield 1106 blocks light that reflects from the display mask 1104 from illuminating the optical sensor.

With regard to FIG. 11E, an exploded view illustration of the electronic display assembly 1100 is shown. In this configuration, three primary structural components are shown, including the housing 1102, touch screen assembly 1118, and trim ring 1105. As described in FIG. 11D, the touch screen assembly 1118 includes a screen 1108 and display mask 1104a, which may be glass covered with conductors extending along the glass and adhered to the screen 1108 and/or ring perimeter frame 1104b. The touch screen assembly 1118 may be attached to the trim ring 1105, which, in turn, may be connected to the housing 1102, thereby forming, at least in part, the electronic display 1100. It should be understood that alternative configurations of the touch screen assembly 1118 may be utilized in accordance with the principles of the present invention.

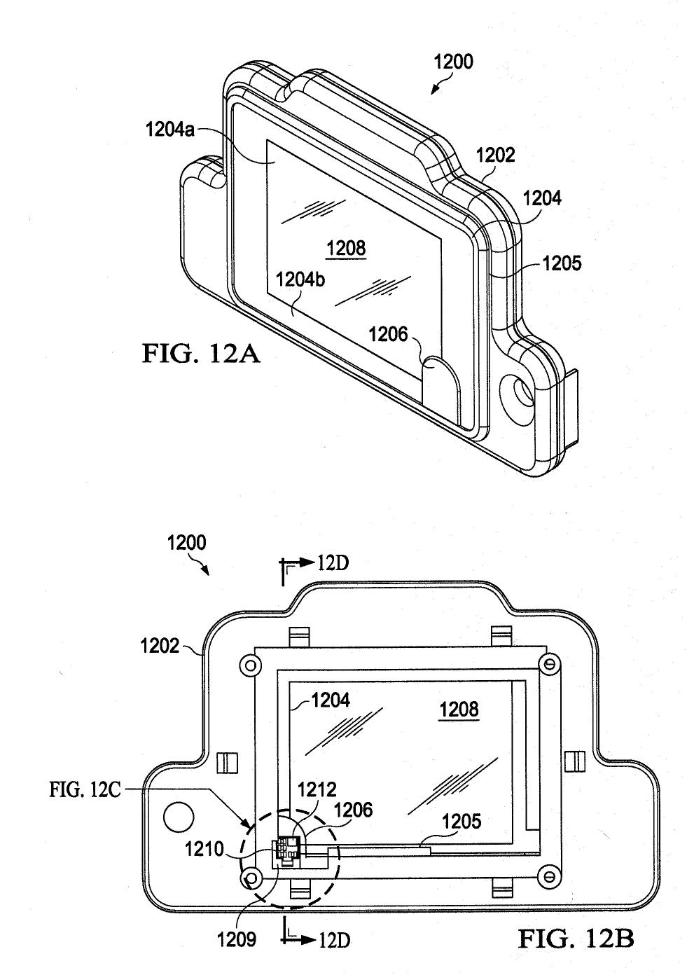

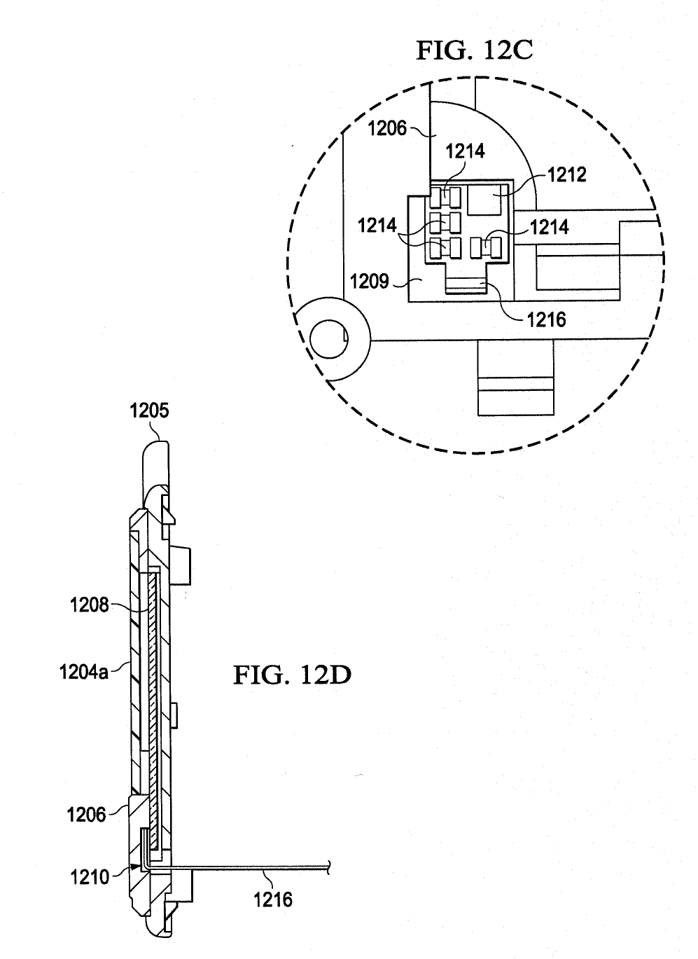

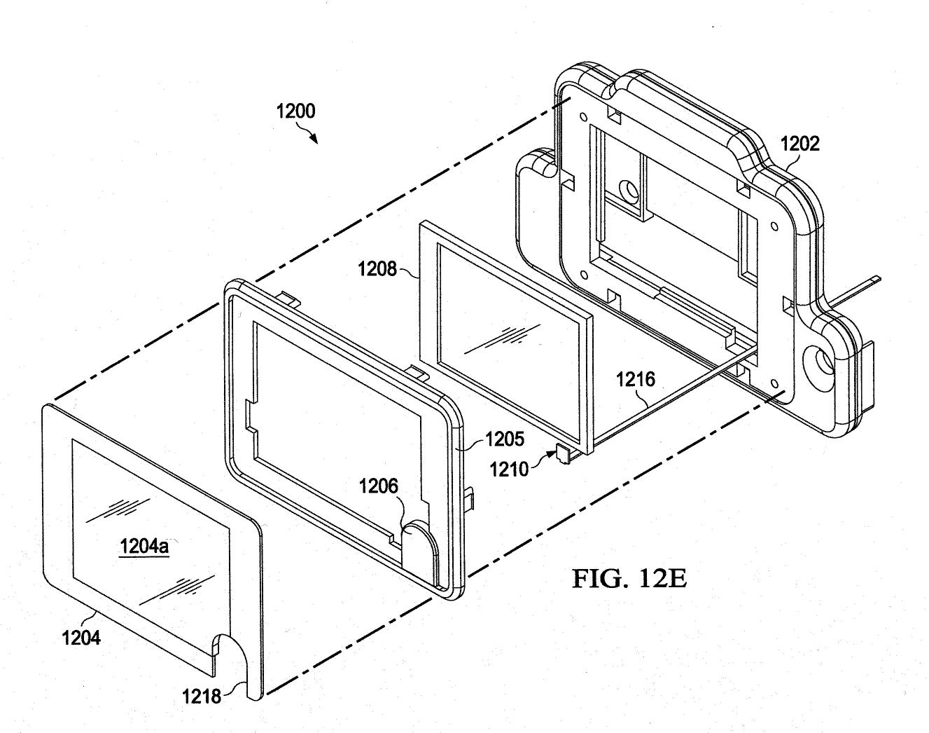

With regard to FIGS. 12A-12E, illustrations of another illustrative electronic display assembly 1200 are shown. As shown in FIG. 12A, the electronic display assembly 1200 includes a housing 1202 and display mask assembly 1204, which includes a display mask 1204a and ring perimeter frame 1204b, as further described below. A trim ring 1205 may include an integrated optical sensor shield 1206. In this embodiment, rather than the optical sensor shield 1206 being circular, the optical sensor shield 1206 is “thumb” shaped and extends horizontally from the side of the electronic display assembly 1200. In being integrated, the optical sensor shield 1206 is molded or otherwise formed as part of the trim ring 1205. In the same manner as previously described with regard to the optical sensor shield 106 (FIG. 1), the optical sensor shield 1206 extends over a portion of a screen 1208 and shields ambient light from illuminating onto an optical sensor (see FIG. 12B) positioned in a cavity (see FIG. 12B) within the optical sensor shield 1206. In an alternative embodiment, the optical sensor shield 1206 may be formed separately from and attached to the trim ring 1205. In the same manner as shown with FIGS. 10A and 10B, a visual verification signal (not shown) may be displayed beneath the optical sensor shield 1206 and extend slightly beyond the perimeter of the optical sensor shield 1206 to provide a viewer an indication that the content is being verified.

With regard to FIG. 12B, an illustration of a rear view of the housing 1202, display mask 1204, and trim ring 1205 of FIG. 12A is shown. The optical sensor shield 1206 is shown to extend over the screen 1208. A cavity 1209 in the optical sensor shield 1206 is sized to accommodate an optical sensor assembly 1210. The optical sensor assembly 1210 includes an optical sensor 1212 that may be mounted to a support structure (e.g., flexible circuit board or printed circuit board). In one embodiment, the optical sensor assembly 1210 may be bonded or otherwise fixedly attached within the cavity 1209 of the optical sensor shield 1206. In yet another embodiment, the optical sensor assembly 1210 may be mounted to the display mask 1204 or other transparent protective covering of the screen 1208. As shown, the optical sensor 1212 may be positioned in a front corner of the optical sensor assembly 1210. Alternative configurations of placement of the optical sensor 1212 may be utilized in accordance with the principles of the present invention.

With regard to FIG. 12C, a magnified illustration of optical sensor shield 1206 and cavity 1208 within which the optical sensor assembly 1210 is positioned. The optical sensor 1212 and other electronic components 1214 (e.g., addressing resistors and capacitors) may be mounted to a flex circuit 1216 for communication of signals received by the optical sensor 1212 to an electronic circuit (not shown) positioned in the electronic display assembly 1200 or remotely therefrom.

With regard to FIG. 12D, a top view of the housing 1202, display mask 1204 and trim ring 1205 is shown. A touch-screen assembly 1218 may include a display mask 1204 with a conductive coating (not shown) and trim ring 1205. The display mask 1204 having the conductive coating provides for touch sensitive capabilities to enable a user to interact with information being displayed on the screen 1208, as understood in the art. The optical sensor shield 1206 is positioned in front of the screen 1208 and display mask 1204, where a minimal or no ambient light may enter between the display mask 1204 and the optical sensor shield 1206. In the event that ambient light can enter between the display mask 1204 and optical sensor shield 1206, the optical sensor (not shown) is positioned in such a way that structure within the optical sensor shield 1206 blocks light that reflects from the display mask 1204 to prevent illumination of the optical sensor.

With regard to FIG. 12E, an exploded view illustration of the electronic display assembly 1200 is shown. In this configuration, four primary structural components are shown, including the housing 1202, screen 1208, trim ring 1205, and display mask assembly 1204. The optical sensor assembly 1210 is positioned in front of the screen 1208, but not the display mask 1204a, as the display mask assembly 1204 is configured to be placed in front of the trim ring 1205 in this embodiment. To fit in front of the trim ring 1205, a cutout 1218 in the ring perimeter frame 1204b and display mask 1204a is sized and shaped to fit around the perimeter of the optical sensor shield 1206. In this embodiment, the display mask 1204a is not touch sensitive. However, in an alternative embodiment, a touch sensitive display may be utilized. It should be understood that a variety of different configurations of display masks and trim rings may be utilized to prevent damage to the screen and reduce or eliminate ambient light from illuminating an optical sensor sensing a verification signal being displayed by a portion of the screen in accordance with the principles of the present invention.

With regard to FIGS. 13A-13F, illustrations of an alternative electronic display assembly 1300 are provided and show front, back, top, bottom, left, and right views, respectively. The electronic display assembly 1300 includes various ornamental design features. It should be understood that certain features shown on the rear of the housing are optionally not part of the ornamental design features as the rear of the housing is not intended to be viewed by viewers looking at a screen of the electronic display assembly 1300.

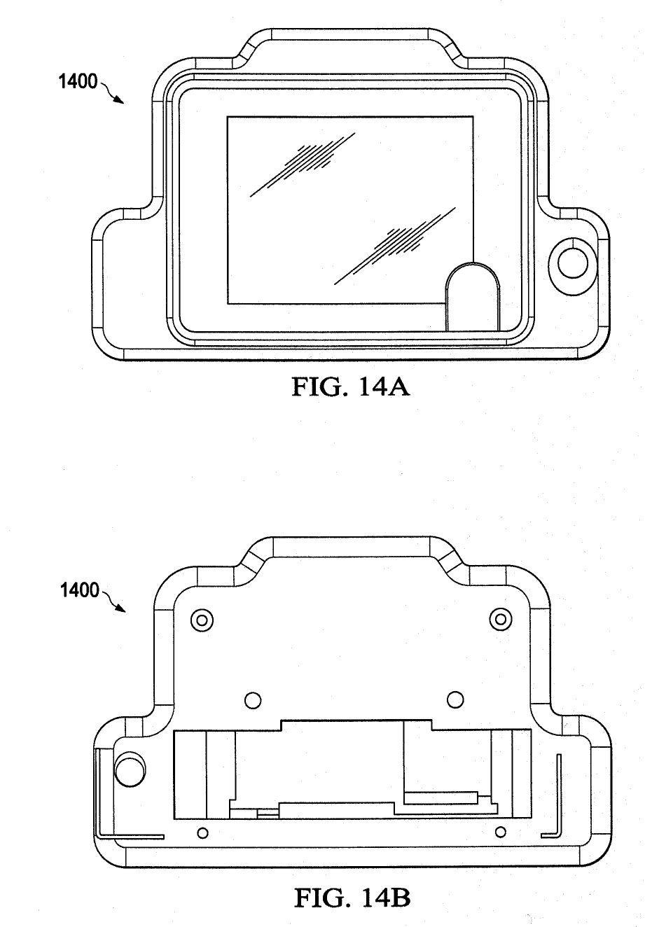

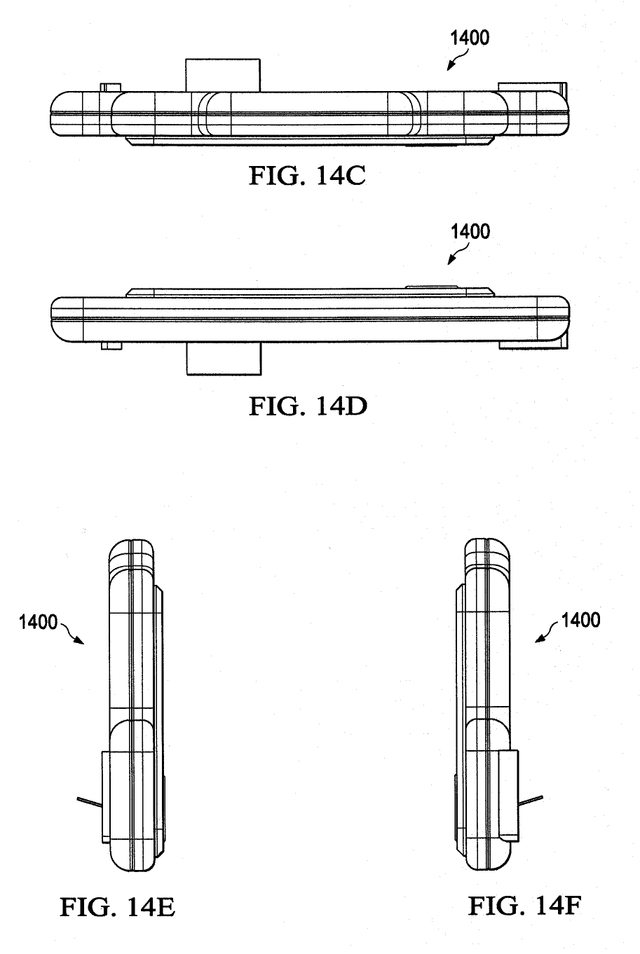

With regard to FIGS. 14A-14F, illustrations of another alternative electronic display assembly 1400 are provided and show front, back, top, bottom, left, and right views, respectively. The electronic display assembly 1400 includes various ornamental design features. As with the electronic display assembly 1300 of FIGS. 13A-13F, certain features shown on the rear of the housing are optionally not part of the ornamental design features as the rear of the housing is not intended to be viewed by viewers looking at a screen of the electronic display assembly 1300.

While the use of an optical sensor shield as described above may be utilized to attenuate or eliminate ambient light from illuminating an optical sensor, alternative configurations may be utilized to attenuate or eliminate ambient light from illuminating the optical sensor with or without the use of an optical sensor shield, as described below.

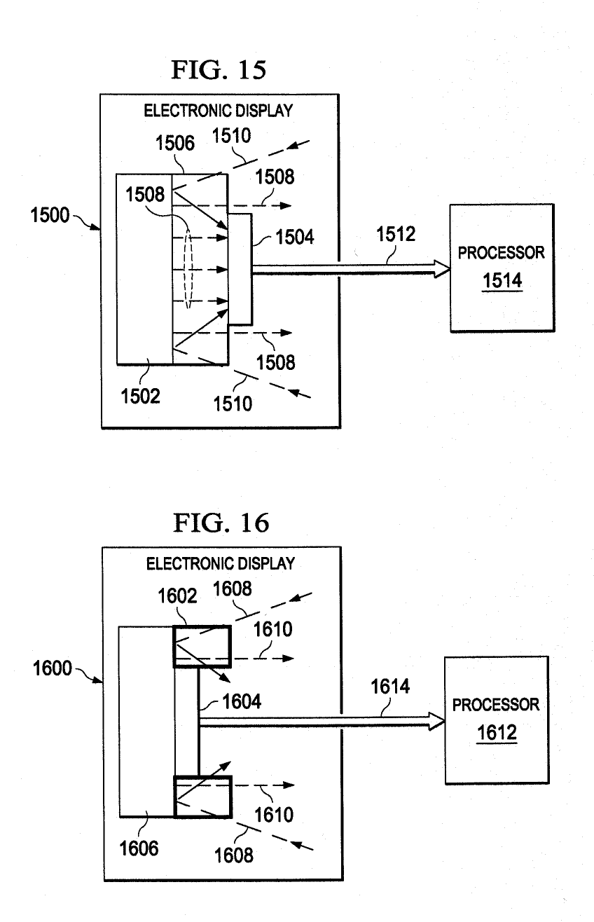

With regard to FIG. 15, an illustration of an illustrative electronic display 1500 that depicts a light emitting element 1502 with an optical sensor or signal sensing device 1504 being positioned on a display surface 1506 of the electronic display 1500 is shown. The light emitting element 1502 may be a liquid crystal device (LCD), light emitting diode (LED) display, or any other light emitting element display, as understood in the art. The light emitting element 1502 may be formed of a matrix of light emitting components, and generate content light rays 1508. The content light rays may represent a visual verification signal, as previously described. As shown, ambient light rays 1508 that enter the display surface 1506 may be reflected from the content light emitting element 1502. The optical sensor 1504 generates a sense signal 1512 that results from sensing the content light rays 1508 (e.g., verification signal) and stray light or ambient light 1510.

A processor 1514, which may be locally or remotely positioned with respect to the optical sensor 1504, that receives the sense signal 1512 produced by the optical sensor 1514 may have problems resolving a content portion of the sense signal 1512 if too much ambient light 1510 or changes in the light illuminating the optical sensor occur due to shadows or increased brightness of the ambient light 1510. The optical sensor 1504 may be mounted to a carrier that allows for mounting to a circuit board or otherwise as described to enable signals generated by the optical sensor 1504 to be more easily accessed.

With regard to FIG. 16, an illustration of an alternative embodiment of an electronic display 1600 including a display surface 1602 being altered in a localized region to enable an optical sensor or signal sensing device 1604 to be positioned therein is shown. In one embodiment, the display surface 1602 may be etched or otherwise altered to form an etched region 1605 so that the optical sensor 1604 is in contact with or positioned slightly in front of the light-emitting element 1606. As shown, the optical sensor 1604 is positioned such that ambient light 1608 cannot enter or is significantly restricted from entering between the content light emitting element 1606 and optical sensor 1604. The etched region of the display surface may be sized and shaped to enable the optical sensor to be fit with or without a gasket or other alignment material or element.

In one embodiment, the optical sensor may be positioned within the etched region using a friction fit or pressure fit such that no adhesive or other fastening element is needed to maintain position of the optical sensor. Alternatively, the optical sensor may be permanently affixed or temporarily affixed to the display surface. Temporarily affixing the optical sensor provides for maintenance at a later date. As a result of the optical sensor 1604 being positioned within the etched region of the display surface 1602, a content light signal 1610, which may be a visual verification signal, that is generated by the content light emitting element 1606 may be sensed by the optical sensor 1604. In one embodiment, the optical sensor 1604 is an Intersil, ISL 29020 optical sensor. A processor 1612 may receive and process a sense signal 1614 generated by the optical sensor 1604 that is primarily or completely resulting from the optical sensor 1604 sensing the content light rays 1610, as the ambient light rays 1608 are restricted or eliminated from illuminating the optical sensor 1604. The processor 1612 may process the sense signal 1614 to determine or compare contents of the sense signal 1614 to determine content (e.g., advertisement) being displayed on the electronic display 1600 associated with the content light signal 1610, time of display, and correctness of display.

The display surface 1602 may be etched so that a thin layer of the display surface remains between the content light emitting element 1606 and signal sensing device 1604, thereby preventing particulates (e.g., dust) from compromising the content light emitting element 1606 and preventing the signal sensing device 1604 from being damaged during installation. The etching of the display surface 1602 may be performed by laser, chemical, or mechanical means, as understood in the art. Using a laser to perform the etching may produce accuracy between different electronic display to another such that manufacturing alignment is maintained. Chemical and mechanical etching of the display surface 1602 may produce the same or similarly accurate results. By using etching techniques of the display surface 1602, installing the optical sensor 1604 to ensure alignment accuracy with respect to pixels of the content light emitting element 1606 is simplified. As a result, a manufacturer merely inserts the optical sensor 1604 within the etched region of the display surface 1602 as opposed to having to align the optical sensor 1604 on top of the display surface 1602.

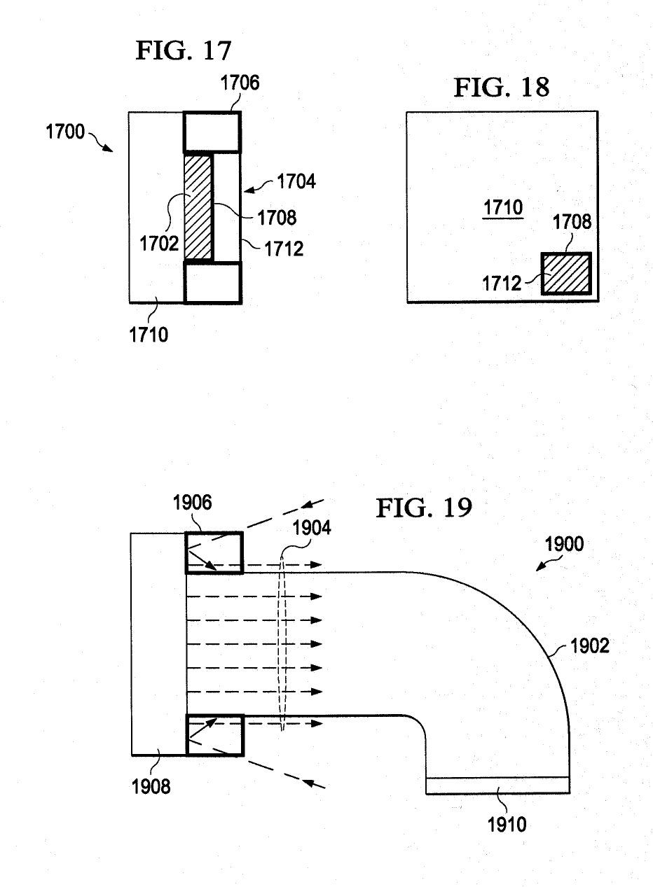

With regard to FIG. 17, an illustration of an illustrative sensing system 1700 including an optical sensor 1702 being positioned within an etched region 1704 of a display surface 1706 of an electronic display is shown. In this embodiment, a gasket 1708 that extends along the sides and rear (i.e., opposite side of the content emitting light element 1710) of the recessed optical sensor 1702 may be used to secure the optical sensor 1702 in the etched region 1704. In one embodiment, the gasket 1708 may be formed of a pliable material, such as rubber or other compressible material, thereby enabling the gasket 1708 to compress as the optical sensor 1702 is pressed into the etched region 1704. The gasket 1708 may be configured to radially surround the optical sensor 1702 in any shape (e.g., circular, square, rectangular) of the optical sensor 1702 including a carrier (not shown) on which the optical sensor 1702 is mounted. Although not shown, any wires or electrical conductors that extend from the optical sensor 1702 may be extended through the gasket 1708 via an opening. A sleeve 1712, which may be formed of any material, may be sized such that the sleeve 1712 fills a gap in the display surface 1706 that extends from the optical sensor 1702 and/or gasket 1708. The sleeve 1712 may be opaque or semi-opaque to further minimize any potential for ambient light to be illuminated onto the optical sensor 1702.

With regard to FIG. 18, an illustration of a front view of the content light emitting element 1710 having the optical sensor (not shown) with the gasket 1708 and sleeve 1712 as shown in the configuration provided by FIG. 17.

With regard to FIG. 19, an illustration of an alternative embodiment of an optical sensing system 1900 that includes a light tube 1902 being inserted into an etched region 1904 of a display surface 1906 of an electronic display is shown. The light tube 1902 guides light that is displayed by the content light emitting element 1908 positioned at the etched region to an optical sensor 1910. The light tube 1902 prevents ambient or other light external from the light tube from being illuminated onto the optical sensor 1910. The light tube 1902 may be an optical fiber or any other form of light tube, as understood in the art. By using the light tube 1902, the optical sensor may be positioned away from being in front of the electronic display to reduce obstructing content being displayed on the electronic display. The light tube 1902 may be permanently or temporarily fastened to the display surface 1906, as previously described.

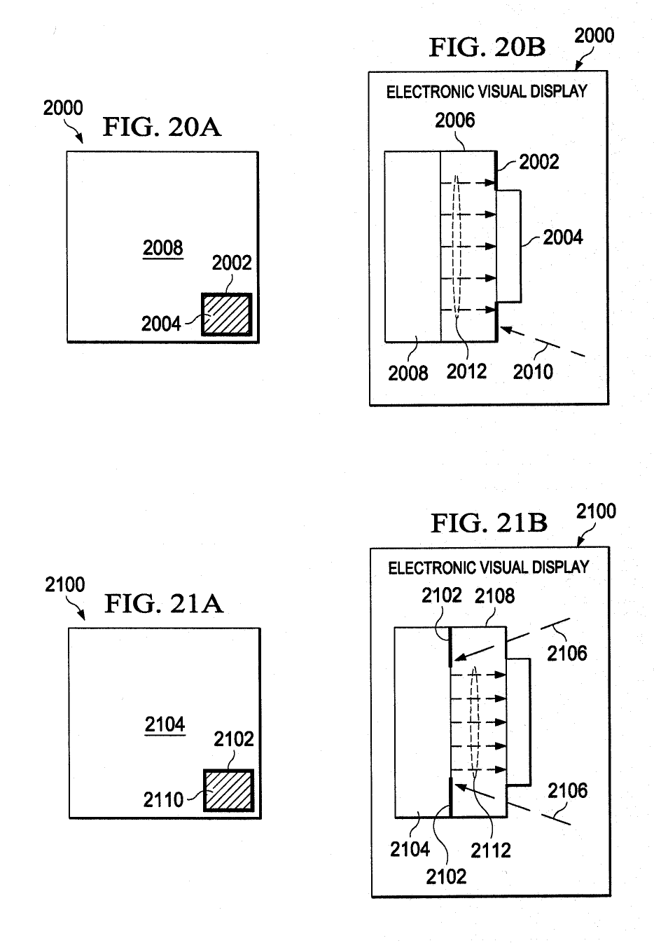

With regard to FIGS. 20A and 20B, illustrations of another embodiment of an optical sensing system 2000 in which an opaque covering 2002 may be disposed on top of an optical sensor 2004 are shown. The opaque covering 2002 may be formed by paint, tape, thin film, or any other material that can assist in blocking ambient light from entering a display surface of a content light emitting element 2008 to reflect onto the optical sensor 2004. The opaque covering 2002 may have dimensions that extend from each of the edges of the optical sensor 2004. The dimensions of the opaque covering 2002 may be set so that ambient light 2010 illuminated onto the optical sensor 2004 is minimized or eliminated so that the optical sensor 2004 senses primarily or totally content light rays or visual verification signals 2012 produced by the content light emitting element 2008.

With regard to FIGS. 21A and 21B, illustrations of yet another embodiment of a light sensing system 2100 in which a region of pixels 2102 of the content light emitting element 2104 around a pixel region (not shown) used to display a verification code are set to black are shown. The pixel region may be a 10×10 pixel array. By setting a pixel region 2102 around the pixel array to black, ambient light 2106 that enters a display surface 2108 of the content light emitting element 2104 is absorbed and/or attenuated by the black color of the pixel region 2102. Such attenuation of the ambient light 2108 reduces illumination of an optical sensor 2110 by the ambient light 2106, and, therefore, improving the ability to sense content light rays 2112 representative of a visual verification signal. In one embodiment, the pixel region 2102 may form a square around the optical sensor 2110. The square of the pixel region 2102 may extend five or more pixels from the perimeter of the optical sensor 2110. It should be understood that various combinations of elements for reducing ambient light from illuminating an optical sensor as described above may be utilized. For example, the optical sensor 2110 may be covered with the opaque covering 2002 to further reduce the ability for ambient light to illuminate the optical sensor 2110.

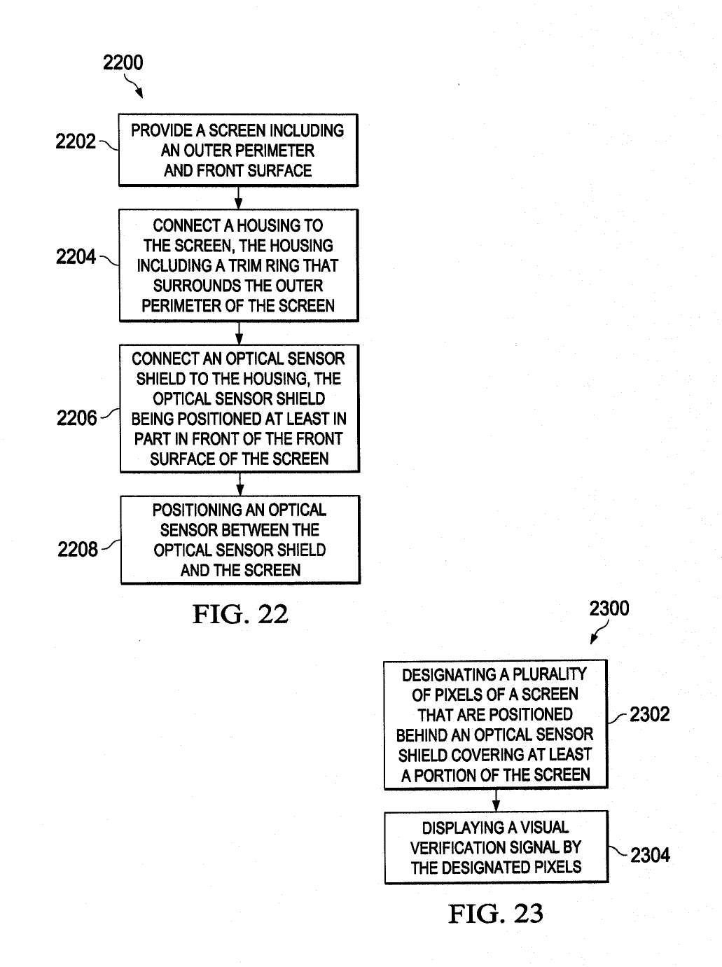

With regard to FIG. 22, a flow diagram of an illustrative process 2200 for manufacturing an electronic display is shown. The process 2200 includes providing a screen including an outer perimeter and front surface at step 2202. At step 2204, a housing may be connected to the screen, where the housing including a trim ring that surrounds the outer perimeter of the screen. In surrounding the outer perimeter, the trim ring may cover or be outside of the outer perimeter of the screen from a front view standpoint. At step 2206, an optical sensor shield may be connected to the housing. In being connected, the optical sensor shield may be connected by structural members of the trim ring and/or housing. In an alternative embodiment, the optical sensor shield may be connected by being manufactured as part of the trim ring or other housing component. The connection of the optical sensor shield may cause the optical sensor shield to be positioned at least in part in front of the front surface of the screen. At step 2208, an optical sensor may be positioned between the optical sensor shield and the screen. It should be understood that the order in which the optical sensor is positioned with respect to connecting the optical sensor shield may be opposite than as described (i.e., positioning the optical sensor may occur prior to connecting the optical sensor shield). The optical sensor may be positioned within a cavity defined by a structural member of the optical sensor shield. Alternatively, the optical sensor may be connected to the screen or a display mask positioned in front of the screen and behind the optical sensor shield.

With regard to FIG. 23, a flow diagram of an illustrative process 2300 for displaying a visual verification signal is shown. The process 2300 starts at step 2302, where multiple pixels of a screen that are positioned behind and adjacent to an outer perimeter of an optical sensor shield covering at least a portion of the screen are designated. At step 2304, visual verification signal may be displayed by the selected designated pixels.

The previous description is of a small number of embodiments for implementing the invention is not intended to be limiting in scope. One of skill in this art will immediately envisage the methods and variations used to implement this invention in other areas than those described in detail.

What is claimed:

1. An electronic display, comprising:
a screen including an outer perimeter and front surface;
a housing including a trim ring that surrounds the outer perimeter of said screen;
an optical sensor shield that is positioned at least in part in front of the front surface of said screen; and
an optical sensor disposed between said optical sensor shield and said screen to reduce the ability for ambient light to illuminate said optical sensor.

2. The electronic display according to claim 1, wherein the optical sensor shield is not coplanar with the screen frame.

3. The electronic display according to claim 1, wherein said optical sensor shield includes a structural element that defines a cavity in which said optical sensor is positioned.

4. The electronic display according to claim 1, wherein said optical sensor is attached to said screen.

5. The electronic display according to claim 4, further comprising pixels being designated for displaying a visual verification signal to illuminate said optical sensor.

6. The electronic display according to claim 5, wherein said pixels include pixels that are beneath said optical sensor shield and adjacent to an outer perimeter of said optical sensor shield.

7. The electronic display according to claim 6, wherein the pixels that are immediately adjacent to an outer perimeter of said optical sensor shield for approximately the same shape as the outer perimeter of said optical sensor shield that extends in front of the front surface of said screen.

8. The electronic display according to claim 1, further comprising a display mask assembly including a display mask that is transparent, the display mask being positioned in front of said screen.

9. The electronic display according to claim 8, wherein said display mask assembly further includes a ring perimeter frame that surrounds a perimeter of the display mask and supports the display mask when the ring perimeter frame is integrated with the trim ring.

10. A method of manufacturing an electronic display, said method comprising:
providing a screen including an outer perimeter and front surface;
connecting a housing to the screen, the housing including a trim ring that surrounds the outer perimeter of the screen;
connecting an optical sensor shield to the housing, the optical sensor shield being positioned at least in part in front of the front surface of the screen;
positioning an optical sensor between the optical sensor shield and the screen.

11. The method according to claim 10, wherein the optical sensor is attached to the screen.

12. The method according to claim 10, further comprising connecting a display mask assembly to the housing, the display mask assembly including a display mask that is transparent, the display mask being positioned in front of the screen.

13. The method according to claim 10, further comprising connecting a display mask assembly to the housing, the display mask assembly including a transparent display mask that is positioned in front of the screen when the display mask assembly is connected to the housing.

14. The method according to claim 13, further comprising:
etching a cavity into the display mask; and
inserting the optical sensor within the cavity.

15. The method according to claim 14, further comprising inserting a gasket into the cavity along with the optical sensor.

16. A method for displaying a visual verification signal, said method comprising:
designating a plurality of pixels of a screen that are positioned behind an optical sensor shield covering at least a portion of the screen; and
displaying a visual verification signal by the designated pixels.

17. The method according to claim 16, wherein designating the pixels includes designating pixels that are disposed at a corner of the screen.

18. The method according to claim 16, wherein designating the pixels includes designating pixels that extend from an outer perimeter of the optical sensor shield and not behind the optical sensor shield.

19. The method according to claim 18, wherein designating the pixels includes designating pixels that at least in part form a circular perimeter.

20. The method according to claim 16, further comprising:
sensing the visual verification signal; and
processing the visual verification signal to determine content being display in association with the visual verification signal.
